(19) United States
(12) Patent Application Publication
(10) Pub. No.: US 2011/0177231 A1
(43) Pub. Date: Jul. 21, 2011

(54) Nano-, Micro-, Macro- Encapsulation And Release Of Materials

(76) Inventor: Alexander Grinberg, San Francisco, CA (US)

(21) Appl. No.: 12/688,879

(22) Filed: Jan. 16, 2010

(51) Int. Cl. B05D 7/00

(52) U.S. Cl. 427/2.14; 427/212

(57) ABSTRACT

This invention relates to nano-, micro-, and macro-encapsulation methods and constructs, including single and multi-compartment particles and capsules, and methods of release.

### BACKGROUND OF THE INVENTION

It is known that targeting and uptake of freely circulating, subcutaneously injected or incorporated molecules, bio-molecules and drugs is poor, undesired toxicity is high, and release is not controllable. Even functionality is often affected. Realization of simultaneous delivery of several molecules is intricate using conventional methods of encapsulation. Although the concept based on “golden bullet” targeting with programmed release capabilities still remains an elusive target, bio-molecules and drugs encapsulated inside nano-, micro-, and macro-particles/capsules with a nano-composite shell as described in this invention are free from these drawbacks. In fact, such encapsulation process not only alleviates the above shortcomings but also allows for functionalization of the outer surface of such delivery vehicles by antibodies and other molecules. This enables additional functionalities such as specific targeting and simultaneous incorporation of multiple molecules with different but specific functionalities and release rates.

The subject of this invention is to provide a versatile encapsulation method based on single- and multi-compartment particles/capsules covering either particles/porous particles and those particles with coatings or capsules. Encapsulation allows protection of incorporated materials, simultaneous incorporation and protection of several molecules, specific targeting or evasion of a designated site, and controlling release rates and release location. The process encompasses the method of formation of multicompartment particles/capsules and multifunctional nano-composite coatings.

A number of encapsulation vehicles are known, among them are liposomes, micelles, polymeric vesicles and capsules, red blood cell ghost based systems, oil-in-water emulsions, and water-in-oil-in-water emulsions. Presented here is a method of encapsulation into single- and multi-compartment particles/capsules providing such advances in encapsulation of bio-molecules and drugs as simultaneous encapsulation of several bio-molecules and drugs, their targeted delivery or evasion of designated sites, and subsequent controllable release. Hallmarks of the delivery vehicles described in this invention are superior stability, multicompartmentalization, elaborate functionalization of the outer surface, and tunable release rates.

### BRIEF SUMMARY OF THE INVENTION

This invention relates to the process of making single- and multi-compartment nano-, micro-, and macro-particles/capsules. Nano-, micro-, and macro-sized, porous and non-porous particles of various shapes including spheres, rods, cubes, ovals, irregularly shaped single and multi-compartment constructs, thus permitting simultaneous encapsulation of several molecules including small (those under 1 kD, for example, substrates for an enzyme-catalyzed reaction) and large (those over 1 kD, for example, an enzyme) molecules, bio-molecules, peptides, proteins, nucleic acids, and drugs. Furthermore, this invention covers methods of encapsulation, manipulation, and release of materials, bio-materials, bio-molecules, and drugs in a broad sense of the term including DNAs, RNAs, siRNA, other oligonucleotides, therapeutic agents, therapeutic agents relevant to the immune-system, therapeutic agents relevant to cancer treatment, ions, salts, medicine, various medical and prescription drugs, gene therapy agents, cytokines, and other materials.

Multifunctional nano-composite coatings or shells are used for (a) protection of encapsulated materials, (b) encapsulation, (c) functionalization by antibodies and other molecules on the outer surface, (d) controlling the release rate of encapsulated materials, and (e) navigation of particles/capsules with time and site specific release. Release, sustained release and controllable release of materials is achieved by tuning the permeability of the nano-composite shell, varying molecules, varying bio-materials, or applying external fields. The two types of release, preprogrammed and at will, occur through bio-degradation of nano-composite coatings or by external fields acting on absorbing centers located in the nano-composite coatings of the delivery vehicles.

Single- and multi-compartment, nano-, micro-, and macro-particles/capsules with nano-composite coatings are the main components of delivery vehicles in all applications of this invention. These structures are used either as an encapsulation matrix or in-situ synthesized by directly incorporating encapsulated materials for protection, delivery and controlled release. Particles or particulate constructs are used as delivery vehicles. In certain preferred embodiments, single- and multi-compartment, nano-, micro-, and macro-capsules and not particles are used as delivery vehicles. The capsules can be obtained from particles by removing the particulate core, also referred to as the template.

Methods of encapsulation into single-compartment particles/capsules are performed via inclusion or entrapment in (a) commercial templates (“post-processed”), (b) synthesized templates (“post-processed” or “during-preparation-of”), (c) through the solvent exchange method, or (d) by stitching into their nano-composite shells. These methods apply to either porous or non-porous particles/capsules. Multi-compartment particles/capsules are comprised of single-compartment particles/capsules either by assembling them together or by synthesizing multi-compartment constructs.

### BRIEF DESCRIPTION OF THE DRAWINGS

FIG. 1 presents schematics of a single compartment particle/capsule. Single compartment particles/capsules represent the simplest case of encapsulation.

FIG. 2 presents schematics of a multicompartment particle/capsule. Multicompartment particles/capsules represent structures with increased complexity: several sub-compartments, either similar or different, carrying similar or different bio-molecules or drugs are combined in a single construct.

FIG. 3 presents schematics of encapsulation by stitching encapsulated materials, bio-molecules or drugs in nano-composite coatings of particles/capsules. Multi-compartmentalization is realized here by encapsulating different materials into different parts of the nano-composite coating and also by incorporation of different materials into the interior of these delivery vehicles.

FIG. 4 presents schematics of particles/capsules in films. Multi-compartmentalization is realized by encapsulating molecules into particles/capsules and directly in the films.

FIG. 5 presents the temporal release profile of a small molecule from the outer sub-compartment of a multi-compartment capsule. A substrate, amplex red, for an enzyme-catalyzed reaction was encapsulated in liposomes which were adsorbed onto the inner core capsule containing an enzyme, peroxidase. Upon disruption of the membrane of the outer sub-compartments by, for example, ultrasound, light, or chemical agents, the substrate was released and penetrated inside the inner sub-compartment capsule thus initiating the reaction. The course of the enzyme-substrate reaction was monitored by confocal laser scanning microscope in fluorescent mode.

FIG. 6 presents the temporal release profile of a small molecule from the outer sub-compartment of a multi-compartment particle. A substrate, amplex red, for an enzyme-catalyzed reaction was encapsulated in liposomes which were adsorbed onto the inner core capsule containing an enzyme, peroxidase. Upon disruption of the membrane of the outer sub-compartments by, for example, ultrasound, light, or chemical agents, the substrate was released and penetrated inside the inner sub-compartment particle thus initiating the reaction. The course of the enzyme-substrate reaction was monitored by confocal laser scanning microscope in fluorescent mode. Drastic difference between the reaction carried out in capsules, FIG. 3, and particles, FIG. 4, can be observed comparing data in these two figures.

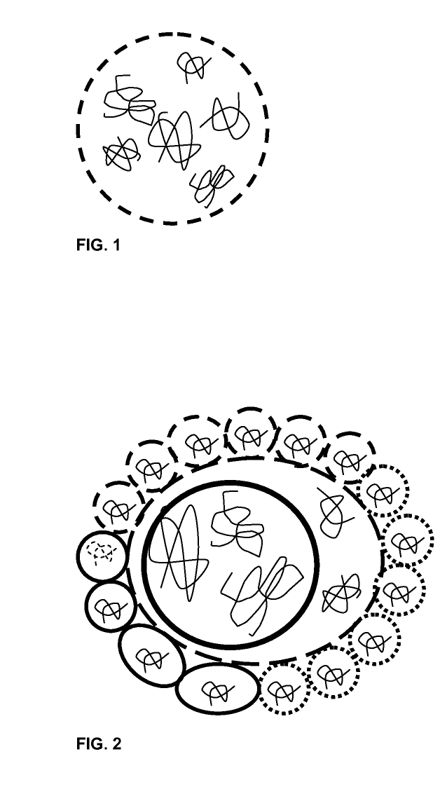

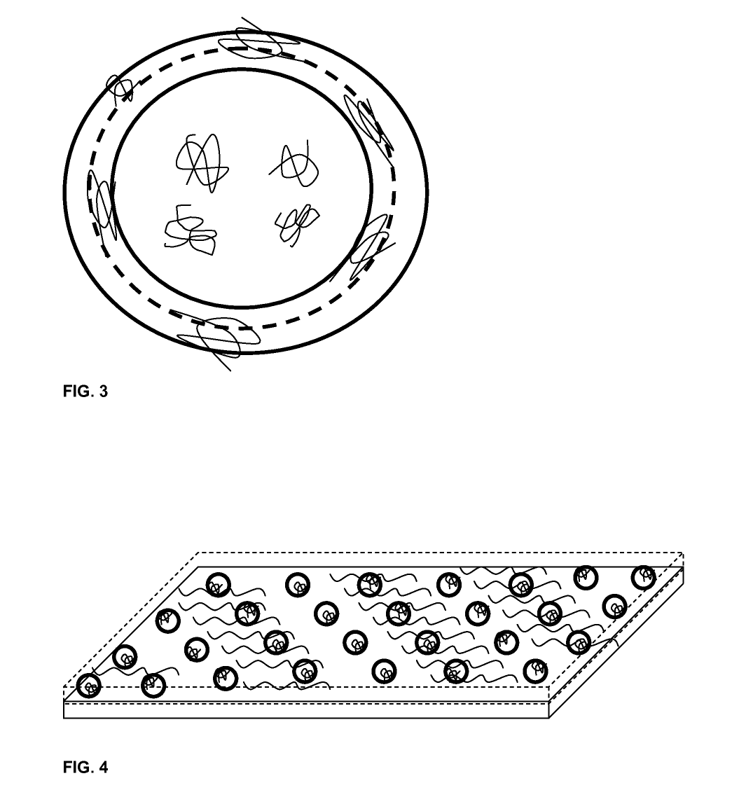

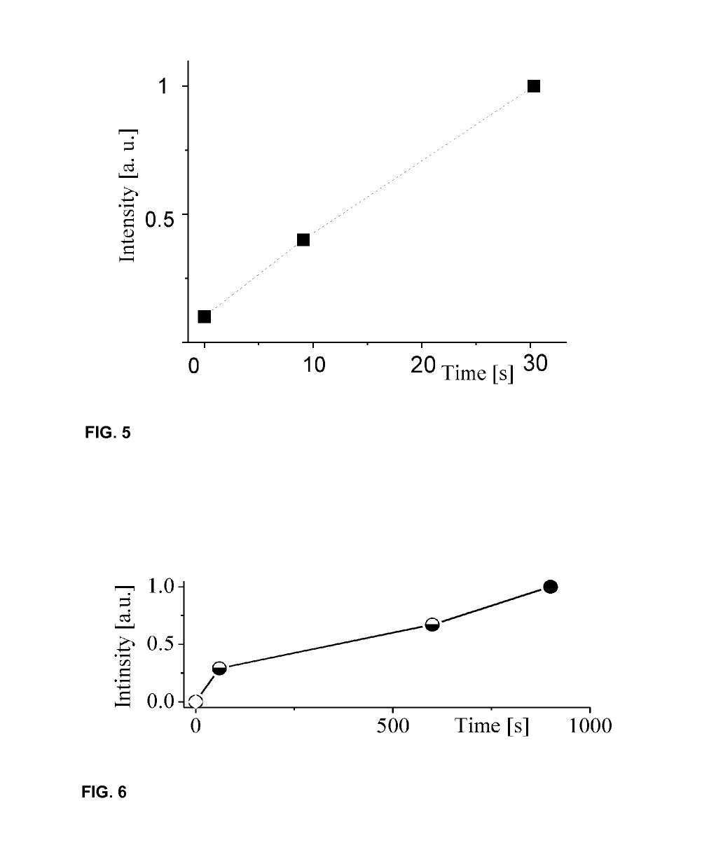

### DETAILED DESCRIPTION OF THE INVENTION

### Encapsulation Environment

The encapsulation environment can be made of water; buffer; various solvents such as organic, aqueous, water miscible, and water immiscible solvents; or air. During encapsulation the materials are exposed to mild conditions so that their structure is not changed or affected.

### Nano-Composite Coatings and their Composition

The key part of encapsulation is the deposition or adsorption of nano-composite coatings or shells around templates or particles. The shell can be made of organic (for instance polymeric), or inorganic (for instance particles or nanoparticles), or a combination of both resulting in the formation of a hybrid organic-inorganic nano-composite shell. The thickness of the nano-composite coating as well as the assembly conditions regulate the release, which is tuned on or during specific time intervals, such as hours, days, weeks, months, and so forth. Immediate release or controllable release can also be achieved by external fields such as light, microwaves, ultrasound, and magnetic fields.

The nano-composite coatings can be comprised of a broad range of materials including polymers, polymeric composites, organic nano-composites, hybrid organic-inorganic particles, nanoparticles (such as noble metals, metal oxides, and magnetic particles), nano-composites, and others. Polymeric nano-composite coatings can be made of individual polymers or combinations of polymers, peptides, charged peptides, proteins, charged and non-charged proteins (such as poly-L-lysine, polyarginine, poly-glutamic acid, gelatin, and collagen), nucleic acids (such as RNAs, DNAs, and siRNA), charged and non-charged polysaccharides (for example, chitosan, dextran sulfate, and hyaluronic acid), water insoluble polymers (such as poly lactic/glycolic acid “PLGA” and polyhydroxibutyrate “PHB”), polymers carrying attached active groups, antibodies, as well as other organic components and inorganic particles, noble metals, metal oxides, and magnetic particles and nanoparticles. “Smart” biodegradable polymeric and nano-composite coatings are used for applications that don't require external release action or stimulus. In case of necessity or technological advantage for a certain purpose, coatings and polymeric coatings can also be applied via spraying.

The shell can be made of a layered structure, in which case incorporation of materials into the shell can be achieved at any sub-layer position. In this case, a template is sequentially covered by polymeric layers. The first layer is adsorbed directly onto a template by mixing polymers with concentrations ranging from 0.001 to 2 mg/ml or higher. Polymers are dissolved either in a buffer, a salt free solution, an aqueous solution, or other solutions either with or without salt. Ionic strength can range from: 0.001 to 1 M of salt, such as NaCl or KCl. In certain preferred embodiments, non-aqueous solution can be also used. After an incubation cycle lasting 1 to 20 minutes, the templates with the adsorbed materials are centrifuged or filtered to separate them from the polymers. Washing the templates 1 to 5 times with water can follow each adsorption cycle. Subsequently, further layers of polymers are adsorbed in a similar fashion. Adsorption can take place through either electrostatic self-assembly, hydrogen bonding, van der Waals interaction, fusion, hydrophilic/hydrophobic interactions, or steric adhesion.

### Templates

Encapsulation is performed on various templates, which are either commercially available or synthesized in-house. The synthesis of templates is an inherent part of the encapsulation process because the templates can be a) synthesized together with the materials to-be encapsulated, and b) used themselves for delivery as particulate delivery vehicles. The synthesized template is used for direct loading of materials during synthesis or post-process loading. Available materials for the templates include calcium phosphate, magnesium carbonate, calcium carbonate, barium carbonate, silica, porous silica, gold, magnetic micro- and nano-particles, and others. The sizes of templates can range from ˜1 nm to 1 mm or higher.

Due to the fact that templates are inherent parts of the encapsulation process and that they can be used themselves for delivery as particulate delivery vehicles, this invention also describes the process of in-house production of templates, including how template production is made as an encapsulation step. Nano-, micro-, and macro-templates are obtained using methods of nano-engineering, which are used to create the structures while controlling their surface, composition, and properties. Fabrication of is conducted upon mixing the template forming materials (such as calcium lactate or calcium nitrate with ammonium hydrogen phosphate; or calcium chloride with sodium carbonate or sodium phosphate), in-situ at various agitation conditions, specifically, from several hundred rounds per minute (RPM) to several thousand RPM. The key signature of this process is admixing upon agitation, steering, or weak steering.

Temperature can be varied from ˜10° C. to 99° C. For reactions carried out at temperatures below RT (room temperature) anisotropic (including rod-like) structures can be formed. At room temperature, symmetrical and spherical structures are formed, while at temperatures above 30° C. smaller (1-3 micron at this temperature versus 5-10 microns at RT) particles can be formed.

Agitation and steering speed upon mixing can be varied from several hundred RPM to thousands of RPM for controlling the size and anisotropy of micro- and nano-templates. Higher steering velocities, those above one thousand RPM are used for producing isotropic mostly spherical templates with a small fraction of non-spherical and anisotropic shapes. Lower steering velocities, those below one thousand RPM lead to production of spherical templates as well as anisotropic templates such as ovals and cubes. For industrial production, crystal-formation inhibitors can be used in production volumes.

The reaction time can be chosen in the range of 0.5 to 10000 seconds. This parameter can be used to tune the size of nano-, micro, and macro-templates. Templates with sizes ranging from 0.5 to 10 micrometers or higher are typically obtained after 10 to 60 seconds of steering, while templates with size less than 3 micrometers are obtained if steering is conducted for less than 10 seconds.

Another method which can be used to control, more specifically to reduce, the size of the templates is pressing through a sieve or milling. In this method templates are deposited in the sieve or grid with nanometer size holes. After direct pressing through these holes or milling, the size of templates is reduced to nanometer.

### Encapsulation

Encapsulation produces a structure with materials freely held inside the capsules, adsorbed onto templates, or stitched into the shell. Such methods are used for controlled delivery, manipulation, targeting, and release in a variety of applications including cell cultures, in-vivo, subcutaneous incorporation, injection, spray-inhalation, perfumes, fragrances, and others. Encapsulation can be performed into porous templates (either commercially available or synthesized) or by stitching into a nano-composite shell. Several methods of encapsulation are available. Either particulate systems or capsules can be used as delivery vehicles.

### Encapsulation into Porous Templates

Either commercially available or synthesized in-house complex nano-composite, porous templates are used for the porous-template based method of encapsulation. The described above synthesis of porous templates is performed by admixing the template forming materials. Then, in the case of porous templates, two routes of encapsulation are possible:
(a) The materials to-be encapsulated are adsorbed into the pores of templates by their direct admixing with the templates and subsequently covered with a nano-composite coatings. The templates are dissolved in water or, if necessary, in a buffer at desired concentrations, such as 0.001 weight percent or 5 weight percent. Encapsulated materials are dissolved in water or, if necessary, in a buffer at concentrations from 1 ng/mL to 5 mg/mL. However, the concentration of encapsulated materials in this step is typically chosen below the maximum dissolution concentration.
(b) Encapsulation can be performed by adding the encapsulated materials during the formation of templates. The conditions for this process are identical to those of the template forming process. Also, the same conditions provide control of the size, shape and anisotropy. Here, the mixing speed, composition and the concentration of to-be-encapsulated materials produce the template enriched or template immobilized materials, which are subsequently covered with nano-composite encapsulating shells. The concentration of encapsulated materials is controlled by their initial concentrations as well as relative amounts of to-be encapsulated material in relation to the template-forming materials; typically the concentration of encapsulated materials is taken in mg/ml.

Single- and multi-compartment, particles/capsules can be functionalized with magnetic nanoparticles giving the delivery vehicles magnetic response capabilities, or metal nanoparticles giving them desired optoelectronic properties, for example, visible or near-IR absorption. The delivery vehicles can be functionalized with other nanoparticles and absorbing particles for imaging and activation purposes. Magnetic, or other metallic including gold and silver, nanoparticles, either commercially available or synthesized in-house, are obtained in a stabilized form. For example, this stabilization can be performed by citrate molecules, which are negatively charged. In the next step, these negatively charged magnetic nanoparticles at any concentration in the range of 10¹⁰-10¹⁷ nanoparticles/mL are added to the solution with templates, particles/capsules. Electrostatic charges, porosity of templates, nano-, micro-, or macro-particles, van der Waals or hydrogen bonding interactions can be used for adsorption.

Porosity of templates in the range of nanometers can be used for in-situ encapsulation. Templates are packed with other materials using direct adsorption. Specifically, the process of packing is performed as follows. The porous templates are dissolved according to encapsulation environment conditions at a desired concentration, from 0.001 to 5 weight percent or higher. The to-be encapsulated materials are dissolved in water or, if necessary, in an appropriate buffer or other solution at a desired concentration, ranging from 0.001 to 3 mg/ml or higher, but below the critical dissolution concentration. Then, upon admixing porous templates and the to be encapsulated materials, the adsorption process takes place. Adsorption is typically conducted under gentle shaking at the frequency of 1-10 Hz. During this absorption, the pores are packed with the to-be encapsulated materials. Porosity; or a combination of porosity and the electrostatic, van der Waals, hydrogen bonding forces; drives the adsorption. Packing with various materials provides partial filling or stacking of the templates with the materials of interest. Simultaneous packing of two- and more materials is also possible.

### Encapsulation into Non-Porous Templates

The key part of this process is the formation of a nano-composite polymer or hybrid nanoparticle-polymer coatings around the template. The nano-composite hybrid coatings are formed either by one time or sequential deposition of polymers around the non-porous template. Polymers are first dissolved in water or, if necessary, in an appropriate buffer or other solution at a concentration such as 0.001 to 3 mg/l or higher, more specifically 2 mg/ml. Then, adsorption onto the non-porous template takes place driven by electrostatic interaction, van der Waals forces, or hydrogen bonding. A one-time deposition is performed, while during sequential deposition a number of deposition steps are repeated. Nanoparticles can also be used at any stage of the shell formation process leading to hybrid nano-composite polymer-nanoparticle shells as described earlier.

For non-porous templates, two routes of encapsulation are possible:
(a) The to-be encapsulated materials are directly adsorbed onto the templates, which are subsequently covered with nano-composite coatings. Then the template can be removed or dissolved, thus forming a hollow capsule, or left intact for realization of a particulate delivery system. Adsorption onto non-porous templates can be conducted using the electrostatic interaction, van der Waals forces, hydrogen bonding, hydrophilic/hydrophobic, or steric interaction. The polymeric shell described above covers the template possessing the to-be encapsulated material adsorbed on its surface or situated in its pores.
(b) The templates are first covered with a nano-composite or hybrid nano-composite shell according to the methods described in (a). Then, the template is removed or dissolved and the to-be encapsulated materials are allowed to penetrate inside the nano-composite shell at normal or increased permeability. This method is suited for encapsulation of molecules with molecular weight>1 kD, for which the polymeric network forming capsule is transparent. The actual process of encapsulation takes place in the next step when the permeability is reduced or drastically reduced, for example upon shrinking or additional adsorption of molecules onto coatings. The shrinking can be conducted using the interplay of hydrophilic and hydrophobic forces. It is applicable to polymers which possess hydrophobic moieties attached to the backbone, such as polystyrene sulfonate or other analogues. This leads to the entrapment and encapsulation of materials. The methods of shrinking can include thermal treatment, acidity of the solution or external fields, all of these methods are conducted reducing the total energy of interaction and reducing the permeability of capsules.

### Encapsulation Via Solvent Exchange

Encapsulation via solvent exchange can be used for encapsulation of various materials. This method of encapsulation is especially useful for incorporation and protection of small (up to 1 kD) molecules. In this method, a water resistant polymeric coating is assembled as described earlier. This part of invention targets the sustained release of small ions of inorganic salts, which is particularly difficult to achieve. In general, the problem with formulating long lasting release compositions occurs due to the high dissolution rate of inorganic salts (calcium carbonate, magnesium sulfates, and others) in water. Each particle is encapsulated in a water resistant cage, which prevents its dissolution. This invention describes the fabrication of the cage or thin coating. The formation of the cage can use steps similar to those used for creation of the coatings according to procedures described earlier. However, the cage formation differs from the coating in that it is performed in another solvent: a non-aqueous solution where materials to-be encapsulated are not soluble. Thus, the polymeric film should be water non-permeable for ions, while on the other hand, for biomedical applications it has to be biodegradable.

Materials can be placed in the form of particles, which can also be compressed to nano- and micro-meter sized crystals. Larger particles can be milled down to a smaller size range. The part of this invention pertaining to encapsulation via solvent exchange is based on the idea of suspending nano-, micro-, or macro-particles in an organic solvent where polymers are dissolved, but the particulate formulation of the to-be encapsulated materials is not dissolved. To facilitate particle dispersion in the organic solvent, lipids or detergents can be used. Lipids compensate the charges on particle surfaces to promote better suspension where hydrocarbon tails of lipids are exposed to the organic phase. Once the particles and polymers are present in the solution, the particles have to be transferred to a water based solution, while some of polymer molecules are placed on the particle surfaces forming the thin coating films.

### Encapsulation of Hydrophilic/Hydrophobic Drugs

Either hydrophilic or hydrophobic drugs can be encapsulated. The devised strategies differ herein that hydrophilic materials, bio-materials, and drugs typically get permeated into the structure of the nano-, micro-, and macro-particles/capsules. Application of polymeric coatings permits keeping hydrophilic materials and drugs within the interior of nano-, micro-, and macro-particles/capsules. Hydrophobic materials are first allowed to penetrate into a porous template in an organic solvent or the organic phase. Then the phase transfer takes place transferring them from organic into aqueous solution or the water phase. Nanocomposite coatings are applied in the next step. The solvent exchange method described above can be used for encapsulation of hydrophilic/hydrophobic drugs.

### Encapsulation by Stitching into the Shell

Encapsulation into both single- and multi-compartment capsules and particles can also be performed by stitching or incorporating to-be encapsulated materials into their shells. In this method, materials encapsulated inside the shell can be added at any step in the polymer coating sequence. Further, to-be encapsulated materials can be covered by a desired number of nano-composite coatings, polymers, and nanoparticles. Nano-composite coatings as described earlier can be used. The composition, dimension, structure, and morphology of the coatings can be chosen according to the desired application. This procedure of encapsulation inside coatings can be done inside the shell of nano-, micro-, and macro-particles/capsules, for example, gold, silica, calcium carbonate, calcium phosphate, etc.

### Capsule Fabrication

In certain preferred embodiments capsules and not particles are used as delivery vehicles. Capsules are obtained from particulate delivery systems by removing the templates. The templates can be removed, by placing them in the solution which dissolves them or adding specific extracts (for example, chelating agents such as EDTA) which decomposes these templates. For example, hydrofluoric acid for silica, hydrochloric acid for calcium carbonate or calcium phosphate, tetrahydrofuran for polystyrene. Removing the template is used mainly for nano-, micro-, and macro-capsules. Alternatively, templates can be kept intact, or not-dissolved, for delivery by particulate systems, specifically nano-, micro-, and macro-particles.

In the case of removing the template, the dissolution does not affect the coating or encapsulated materials. The encapsulated materials thus remain freely floating inside the nano-, micro-, and macro-single and multi compartment capsules.

### Multi-Compartment Particles/Capsules

Multi-compartment particles/capsules, either coated with nano-composite coatings or uncoated, are constructs comprised of more than one sub-compartments in the same delivery vehicle. The number of sub-compartments is flexible and is limited only by the desired overall size or. All methods of encapsulation and manipulation of permeability of nano-composite coatings described above are applicable to multi-compartment particles/capsules. These elaborate multi-compartment structures allow for novel methods of simultaneous encapsulation of similar or different materials, bio-molecules, and drugs. Specifically, preparation of nano-, micro-, and macro-, multi-compartment particles/capsules with several sub-compartments can be done using two main approaches.

In the first method by sequential fabrication of the outer sub-compartment around the inner sub-compartment, the outer shell is built-up around the existing particle described in the porous templates section. The prepared templates are immersed into a solution containing materials for template preparation and the procedure of preparing templates is repeated again.

In the second so-called direct adsorption approach, multi-compartment nano-, micro-, and macro-particles/capsules are fabricated from above described nano-, micro-, and macro-particles/capsules wherein the latter serve as sub-compartments of multicompartment structures. Nano-particles carrying active compounds can be synthesized by similar methods as micro-particles by decreasing the time of the reaction (to several seconds) and decreasing the temperature. Such particles/capsules can be attached or adsorbed by direct mixing of smaller (those with sizes between 1 nm and 1000 nm) micro- and nano-particles/capsules to other typically larger sized particles/capsules (1 nm to 1000 mm) thus forming multi-compartment particles/capsules. These particles/capsules can be coated by polymers according to the procedure described above as in the porous templates section. The inner and outer sub-compartments can be made of similar or different sub-compartments. For example, of a particulate or capsule-like inner core identical particulate or capsule-like constructs can be adsorbed. In this case the concentration of the outer sub-compartments relative to inner sub-compartment regulates the concentration of the particles/capsules on the periphery of the inner core. Specifically mixing particles/capsules at concentration 1:n where n>2 leads to multiple compartments around the inner compartments. Alternatively, different delivery vehicles can be adsorbed onto the inner core. For example, liposomes, micelles, dendrimers, nanoparticles, or oils, either coated or non-coated with nano-composite coatings, can be adsorbed onto the inner core. Also, similar or different sub-compartments can hold either similar or different molecules. The release rates of these molecules can be controlled individually.

Multi-compartment particles/capsules are targeted for simultaneous delivery of several drugs. It is particularly important in applications requiring (a) simultaneous delivery of different molecules/substances, (b) delivery of similar molecules with significantly different release rates, (c) substances with complementary functionalities, for example, a curing agent in one compartment and gene repair agent in an adjacent compartment.

Multi-compartment particles/capsules can be made of similar or different compartments. Specifically, different compartments made of particles/capsules, liposomes, micelles, dendrimers, or red blood cell ghosts, with or without nano-composite coatings, comprising the inner core, while the outer core or other compartments can be comprised of liposomes intended for delivery of small molecules (under 1 kD), micelles, dendrimers, red blood cell ghosts, oils, and others. An enzyme-substrate reaction using the same multicompartment delivery vehicle is an example of a specific application.

### Modification of Nano- and Micro-Particles/Capsules

The nano-composite shell of macro-, nano-, and micro-composite capsules can be modified by appropriate agents, such as pegylation, to avoid an uptake and promote circulation. On the other hand, the capsules can be modified to induce site-specific uptake by, for example, attachment of an antibody to its outer surface. The capsule is modified to induce site specific uptake, for purposes such as mimicking a carbohydrate receptor. If a micro- or nano-capsule/particle is attached to the desired site, subsequent incorporation into cells can be tuned by sizes and chemical composition. Modification of nano- and micro-particles/capsules can be performed at any time in the production or post-production cycle.

Nano-composite polymeric coatings for encapsulation and nano-encapsulation of small molecules are enhanced by hydrophobic/hydrophilic polymers, sol-gel coatings, or oil-based coatings. Lipid coatings are used on micro- and nano-capsules and particles for enhancement of permeability, structure, and specificity of the surface modification.

### Release Methods

The methods of release relate directly to the means of controlling permeability of the outer shell of particles/capsules. There are two main methods of release: bio-degradability, an inherent property of bio-degradable polymers, and application of an external field. In the former case, polymer coatings are chosen ensuring the action of enzymes or other bio-molecules in-vivo or in-vitro. In the latter case, the shell of nano-, micro-, or macro-particles/capsules is functionalized with nano-complexes, for example metallic or magnetic nanoparticles. An external field (for example, electromagnetic irradiation in the frequency range of light, visible light, X-ray, microwave, and radio-frequency or ultrasound or magnetic field, including MRI) affects those particles to provide the permeability change of the capsule/particle coatings. In all cases, the encapsulated materials can be released from capsules in a desired release sequence or release profile. Release can be tuned at any interval between a few seconds and a few months.

### EXAMPLES

Without intention to limit the scope of this invention in any manner, the following examples are provided here to illustrate various realizations of the invention.

### Example 1

Drug encapsulation into particles. Encapsulation of drug (for example, rapamycin) was conducted into pores of, for example, ˜5 micrometer calcium carbonate porous microparticles. Aceton solution of MTX of concentration of 5 mg/mL was mixed with, for example, porous calcium carbonate particles of amount of 20 mg/mL in acetone. After shaking for 2 hours (in a standard laboratory shaker) the particles were sedimented by centrifugation. The speed of centrifugation can hold 1-3 kRPM (revolutions per minute). Alternatively, the solution with particles was filtered or let stay for sedimentation for several hours. Rapamycin solution filled the voids (pores) in porous calcium carbonate particles. After substitution of acetone with water the rapamycin molecules precipitate in pores of the calcium carbonate particles. Nano-composite coatings over the calcium carbonate particles were deposited either by coacervation or adsorption of polymers (dextrane sulfate, MW 70 kD) in an aqueous solution. The latter step was repeated with addition of another polymer (poly-L-arginine, MW 70 kD); multiple application of polymers (from 4 to 12) was used to obtain a desired thickness of the nano-composite coatings. Concentration of polymers was chosen at 2 mg/mL; experiments were conducted with polymers dissolved either in PBS buffer or 0.5 M NaCl aqueous solution. These particulate systems were used as drug delivery vehicles.

### Example 2

Bio-molecule encapsulation into capsules. Encapsulation of bio-molecule (for example, dextran, MW 10 kD) was conducted into pores of, for example, ˜3 micrometer calcium carbonate porous microparticles. After shaking dextran bio-molecules together with calcium carbonate particles for 30 minutes (in a standard laboratory shaker) the particles were sedimented by centrifugation. The speed of centrifugation can hold 1-3 kRPM. Alternatively, the solution with particles was filtered or let stay for sedimentation for several hours. Dextran filled the pores in porous calcium carbonate particles. Subsequently, nano-composite coatings over the calcium carbonate particles with dextran bio-molecules in the pores were deposited either by coacervation or adsorption of polymers (dextrane sulfate, MW 70 kD) in an aqueous solution. The latter step was repeated with addition of another polymer (poly-L-arginine, MW 70 kD); multiple application of polymers (from 4 to 12) was used to obtain a desired thickness of the nano-composite coatings. Concentration of polymers was chosen at 2 mg/mL; experiments were conducted with polymers dissolved either in PBS buffer or 0.5 M NaCl aqueous solution. In this application, the particles were dissolved in EDTA (0.2 M, pH 7.5) and so prepared capsules filled with dextran bio-molecules were used for delivery.

### Example 3

Encapsulation Via Solvent Exchange Method. Biodegradable polymer PHB is dissolved in concentration 5 mg/ml in chloroform. This solution also contained 5 micron sized calcium carbonate particles in amount 50 mg/ml. Quality of polymer solution is getting worse for PHB by dropping non-solvent, in this case acetone was drop-wise added in chloroform solution of PHB at continuous stirring. Calcium carbonate particles suspended in an aqueous solution harvested the precipitating polymers on their surfaces. After about ˜50 minutes chroroform evaporates and calcium carbonate are coated with PHB polymers in acetone. Then the particles are centrifuged and transferred to ethanol or acetone and later via another centrifugation step to water. The rest of polymers in solution is removed after the first centrifugation. Adding surfactants (for example, lipids, such as PDDC at concentration of 1 mg/mL) during suspension in ethanol facilitates the process and prevents particles aggregation.

### Example 4

### Nanocomposite Coatings and Subsequent Release

˜5 micron calcium carbonate particles were used for encapsulation of an active drug, for example, doxorubicin (DOX). Specifically, DOX was deposited in the pores of the particles which were coated with polymeric nano-composite films. biodegradable polymers (PHB) and suspended in water. Deposition of inorganic nanoparticles (20 nm iron oxide) was made by simple adsorption on polymer surface of particles. Adsorption was conducted at iron oxide particles concentration of 5 mg/mL during 30 minutes and rest of iron oxide particles were washed out by centrifugation of coated 5 micrometer calcium carbonate particles with drug. Ultrasound applied at frequency of 1.2 MHz and power of 0.2 Watt for 1 hour resulted in breakage of nano-composite shell and release of drug (DOX).

### Example 5

Multi-compartment micro- and nano-particles obtained by direct adsorption. Larger calcium carbonate particles (diameter ˜3-5 μm) were resuspended for 2 hours under shaking in tetramethylrhodamine isothiocyanate-dextran solution (TRITC-dextran, Mw=150 kDa) (1 mg/mL). Nano-composite coatings over the calcium carbonate particles were deposited either by coacervation or adsorption of polymers (dextrane sulfate, MW 70 kD) in an aqueous solution. The latter step was repeated with addition of another polymer (poly-L-arginine, MW 70 kD); multiple application of polymers (from 4 to 12) was used to obtain a desired thickness of the nano-composite coatings. Concentration of polymers was chosen at 2 mg/mL; experiments were conducted with polymers dissolved either in PBS buffer or 0.5 M NaCl aqueous solution. Smaller silica particles (with the average size 1 μm were coated also coated with nano-composite coatings as described above. Adsorption of these smaller particles (0.5 mL, 50 mg/ml) onto larger CaCO₃ particles (0.1 mL, 50 mg/ml) with loaded TRITC. Concentration of the smaller particles on the bigger particles was controlled by adjusting relative concentrations of these particles; 1:n where n>10 was used to obtain multi-compartment particles with multiple smaller sub-compartments.

### Example 6

Multi-compartment Micro- and Nano-Capsules Obtained By Sequential Fabrication. Calcium carbonate particles were mixed with tetramethylrhodamineisothiocyanate (TRITC), human serum albumin (HSA) and magnetic nanoparticles. This precursor was further coated with nano-composite coatings described above. Further, the initially coated particles were subjected to the second reaction step which involved calcium chloride and sodium carbonate (both at 0.3 M) in the presence of Alexa Fluor 488. The Alexa-HSA particles were collected by applying a magnetic field. These precursors were further coated with nano-composite coatings described above.

### Example 7

Multi-compartment Micro- and Nano-Capsules Obtained By Direct Adsorption Or Sequential Fabrication. Multi-compartment capsules produced either by direct adsorption or sequential fabrications are obtained from respective multi-compartment particles whose description is provided above. Dissolution of calcium carbonate particles was conducted by EDTA, while dissolution of silica particles was conducted by hydrofluoric acid.

### Example 8

Monitoring Reaction in Multicompartment Micro- and Nano-Particles And Capsules. An enzymatic reaction in multi-compartment microcapsules were conducted according to the following procedure. CaCO₃ particles (˜5-6 μm diameter) were incubated under agitation with peroxidase (POD, Sigma-Aldrich) (1 mg/mL in 10 mM TRIS buffer, pH 7.4) for 20 min at room temperature. After agitation, the mixture was washed three times in Milli-Q water. The resulting particles with loaded POD were then coated with nano-composite coatings of PSS (poly(sodium 4-styrenesulfonate); Mw=70 kDa) and PAH (poly(allylamine hydrochloride); Mw=70 kDa) (2 mg mL⁻¹ in 0.5 M NaCl). CaCO₃ dissolution was performed by treatment with EDTA as described above. The enzymatic activity of POD was estimated by adding 25 μM H₂O₂ and 50 μM Amplex Red in dimethyl sulfoxide to the capsule solution. 1,2-dioleoyl-sn-glycero-3-phosphocholine (DOPC, Sigma-Aldrich) liposomes were prepared by dissolving lipids in chloroform. After the evaporation of the organic solvent under nitrogen stream and drying under vacuum overnight, a film of lipid molecules was formed. The obtained film was hydrated with HEPES buffer (10 mM HEPES, 2 mM CaCl₂, 150 mM NaCl, pH 7.4) containing 0.75 mM Amplex Red (Invitrogen) under vortexing in order to accelerate lipids to come in suspension. The obtained multilamellar liposome vesicles were extruded several times through a polycarbonate membrane (100 nm diameter pore size) mounted in an extruder. Further, liposomes were dialyzed against HEPES buffer using a cellulose membrane with exclusion pore size of 10 kDa. The liposomes were slightly positively charged and had sizes in the range of (152.3±4.6) nm. Calcium carbonate capsules and particles with loaded POD were further incubated for 20 min. with gentle shaking with DOPC liposomes containing Amplex Red. The obtained suspension was then centrifuged and washed with Milli-Q water. Further, the suspension was sonicated for 5 min at room temperature in a standard laboratory sonicator (Power 200 W). The reaction between Amplex Red and POD was monitored in situ by CLSM (confocal scanning laser microscope) before and after the sonication.

### Example 9

Multicompartment Micro- and Nano-Capsules In Films. Polymeric films were prepared by sequential deposition of polystyrene sulfonate either sodium salt (PSS) and poly(diallyldimethylammonium chloride) (PDADMAC) or poly-L-lysine (PLL) and hyaluronic acid (HA). The films were deposited onto a microscope cover glass, which was cleaned before the deposition. The film was deposited at room temperature by alternating dipping of the glass slides into either PSS (1 mg/mL) and PDADMAC (1 mg/mL) (both in water with 0.5 M NaCl) or PLL (0.5 mg/mL) and HA (0.5 mg/mL) solutions in Tris-buffer with an intermediate washing step with the buffer. Each dipping step lasted over 12 min. After preparation, the films micro- and nano-capsules previously described in this patent were deposited in the films producing films functionalized with micro- and nano-capsules.

What is claimed is:

1. The method of encapsulating various materials, bio-materials, and bio-molecules in nano-, micro-, and macro-, single and multi compartment particles/capsules by incorporation during or post synthesis using (a) porous or non-porous composite particles/capsules or (b) nano-composite coatings;

2. The method of claim 1, where the particles/capsules are fabricated as multi-compartment constructs comprised of two or more compartments;

3. The method of claim 1, where bio-molecules and drugs are incorporated into porous or non-porous templates before, during, or after the template synthesis;

4. The method of claim 1, where encapsulation of hydrophilic materials and drugs into porous or non-porous templates is performed before, during, or after the template synthesis;

5. The method of claim 1, where the release rate from the particles/capsules is preprogrammed in the nano-composite coating and assembly conditions;

6. The method of claim 1, where release from the particles/capsules is achieved by external stimuli;

7. The method of claim 1, where encapsulation is performed by the solvent exchange method;

8. The method of claim 1, where the structural stability and release profile is controlled by additional binding within the nano-composite shell;

9. The method of claim 1, where bio-molecules and drugs are incorporated in the nano-composite shell;

10. The method of claim 1, where the outer polymeric shell is made with active groups, polymers possessing active groups, or antibodies to promote binding to cells and tissue;

11. The method of claim 1, where the outer polymeric shell is modified to evade binding to other cells and tissues;

12. The method of claim 1, where the capsules are functionalization with magnetic, metallic, fluorescent particles, nanoparticles, or dyes;

13. The method of claim 1, where the bio-compatible and bio-degradable polymeric nano-composite coatings respond to various pH values, external electromagnetic fields, or digestive enzymes to control the release profile;

14. The method of claim 1, where the coatings are pegylated or modified with active groups, polymers, peptides, or proteins with or without active groups;

15. The method of claim 1, where macro-, micro- and nano-particles/capsules are adsorbed onto planar surfaces and stents covered with nano-composite coatings;

16. The method of claim 2, where one or more compartments of a multi-compartment particle/capsule are obtained by direct adsorption of sub-compartments onto the inner-sub-compartment particle/capsule;

17. The method of claim 2, where one or more compartments of a multi-compartment particle/capsule are obtained by sequential fabrication of the outer sub-compartments around the inner-sub-compartment particles/capsules;

18. The method of claim 2, where multi-compartment particles/capsules encapsulate different molecules, bio-molecules, or drugs by stitching these materials into the shells of the compartments;

19. The method of claim 2, where multi-compartment particles/capsules are comprised of different sub-compartments with different release rates;

20. The method of claim 2, where multi-compartment particles/capsules are comprised of a combination of different delivery vehicles including particles, capsules, vesicles, liposomes, micelles, dendrimers, nano- and micro-particles, red blood cell ghosts, emulsions with similar or different molecules, bio-molecules, or drugs.
